(19) United States
(12) Patent Application Publication
(10) Pub. No.: US 2024/0261916 A1
(43) Pub. Date: Aug. 8, 2024

(54) MULTIPLE-AXIS MACHINING CENTER WITH A TOOL MAGAZINE

(71) Applicant: VIGEL S.P.A., Borgaro Torinese (IT)

(72) Inventors: Diego STABIO, Nole (IT); Daniele FRANCESIA VILLA, Mezzenile (IT)

(21) Appl. No.: 18/564,949

(22) PCT Filed: Oct. 12, 2021
(86) PCT No.: PCT/EP2021/078169

§ 371 Date: Nov. 28, 2023

(30) Foreign Application Priority Data
Jun. 10, 2021 (IT) 102021000015131

(51) Int. Cl. B23Q 1/52; B23Q 1/54; B23Q 11/08

(52) U.S. Cl. CPC B23Q 1/525; B23Q 1/5406; B23Q 11/08

(57) ABSTRACT

A machining center includes two independent carriages that are supported so that they can slide along respective longitudinal translation axes by a pair of parallel horizontal rails which are extended along a longitudinal direction and are fixed in a raised position to a supporting structure. Each one of the carriages supports a machining head which can move along a transverse translation axis and along a vertical translation axis by guiding components. Each of the machining heads supports a tool holding spindle so that it can rotate about a horizontal rotation axis by rotary support components. A workpiece holding table is supported at a base of the supporting structure so that it can rotate about a first rotation axis which is extended in a horizontal and longitudinal direction. Two mechanized tool magazines at the opposite longitudinal ends of the supporting structure are accessible by the spindles.

### CROSS-REFERENCE TO RELATED APPLICATIONS

This application is a 35 U.S.C. § 371 National Stage patent application of PCT/EP2021/078169, filed on 12 Oct. 2021, which claims the benefit of Italian patent application 102021000015131, filed on 10 Jun. 2021, the disclosures of which are incorporated herein by reference in their entirety.

### TECHNICAL FIELD

The present disclosure relates to a multiple-axis machining center with a mechanized tool magazine.

### BACKGROUND

As is known, a multiple-axis machining center can comprise generally a motorized tool holding spindle mounted on a machining head which can move along two or more axes, with respect to the workpiece, so as to subject the workpiece to successive different machining processes such as milling, boring, tapping, and the like.

The axis of the spindle may be arranged horizontally or vertically.

It is also known to provide machining centers of the above cited type with a mechanized tool magazine, from which the spindle automatically picks up the tools to be used in the various machining steps, utilizing the mobility in space of the machining head.

A tool magazine of a known type, particularly appreciated for its reliability, comprises a motorized tool holding drum. In the case of a spindle with a horizontal axis, the tool holding drum can be arranged in front of the spindle so that its is axis horizontal and at right angles to the axis of the spindle, so as to present to the latter the tools to be picked up.

In order to increase productivity, the machining center can also be provided with multiple parallel spindles mounted on a single machining head, so as to machine multiple workpieces simultaneously.

Machining centers of the above cited type, while highly appreciated for their machining precision and their productivity—since they can perform numerous machining processes on the workpiece with a single positioning operation—however have the limitation of being suitable especially for machining medium-small workpieces, e.g., small mechanical parts in the automotive sector or in the industrial sector.

Larger workpieces, such as portions of the chassis or body of a vehicle, currently can be subjected to successive machining processes on different machine tools, with a consequent drastic reduction in productivity and in machining precision, since the workpiece must be repositioned each time it is transferred from one machine tool to the next.

So-called multitasking machines are known which are capable of performing different machining processes on large workpieces, but they too are limited in terms of productivity, since they have a single spindle which can move with respect to multiple axes, e.g., five axes.

Furthermore, known multitasking machines, despite using a single spindle, are extremely bulky and therefore difficult to place within the production facility.

### SUMMARY

Therefore, the aim of the present disclosure is to provide a multiple-axis machining center with mechanized tool magazine that is capable of machining large workpieces, such as portions of the chassis or body of vehicles, while having substantially the same machining versatility and the same dimensions as machining centers designed to machine medium-small workpieces.

Within this aim, the disclosure provides a multiple-axis machining center that has a much higher productivity than currently known multitasking machines for machining large workpieces.

This aim and these advantages that will become better apparent from the description that follows, are achieved by providing a machining center as set forth in the independent claim, while the dependent claims define other advantageous characteristics of the disclosure.

### BRIEF DESCRIPTION OF THE DRAWINGS

The disclosure is now described in greater detail with reference to some preferred but not exclusive embodiments thereof, illustrated by way of non-limiting example in the accompanying drawings, wherein:

FIG. 1 is a schematic plan view of a machining center according to the present disclosure; and

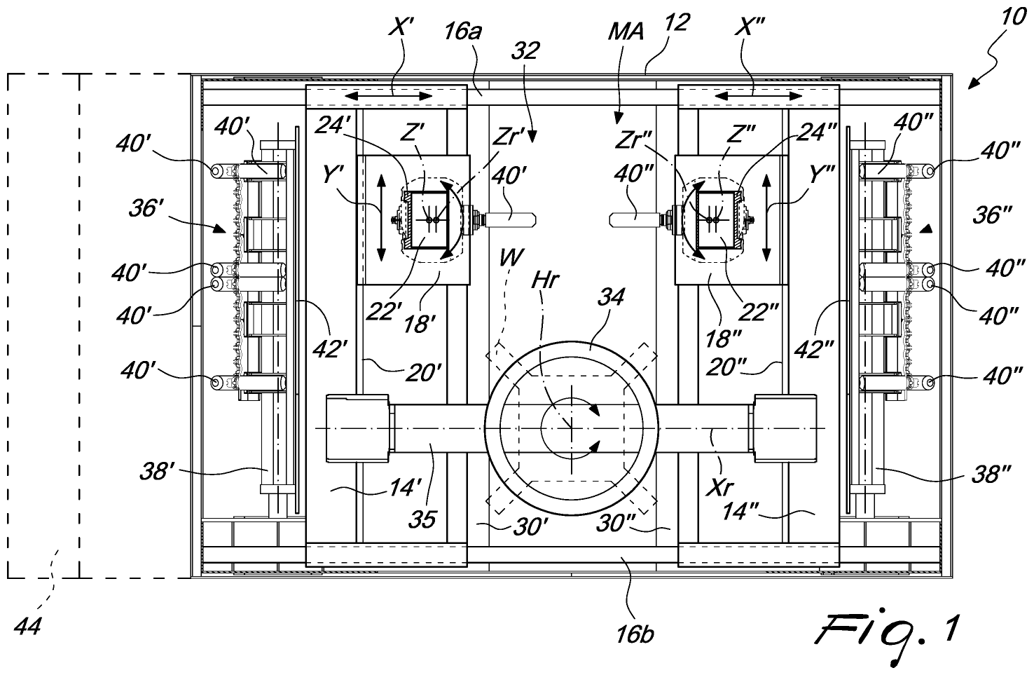

FIG. 2 is a schematic lateral elevation view of the machining center of FIG. 1.

### DETAILED DESCRIPTION OF THE DRAWINGS

With reference to the figures, a machining center 10 according to the disclosure comprises a supporting structure 12, which in the illustrated schematic embodiment has a box-like profile, in which a work area MA is defined.

Two independent carriages 14′, 14″ are supported so that they can slide by a pair of parallel horizontal rails 16a, 16b, which are fixed in a raised position, preferably at the upper end, of the supporting structure 12 and are extended in a longitudinal direction.

Each of the two carriages 14′, 14″ can therefore slide along a respective longitudinal translation axis X′, X″.

Each of the two carriages 14′, 14″ supports a respective slider 18′, 18″ which can slide along a respective horizontal guide 20′, 20″ which is integral with the carriage 14′, 14″ and is extended along a respective transverse translation axis Y′, Y″.

Each of the sliders 18′, 18″ supports a respective machining head 22′, 22″, which in turn is supported slidingly on a respective vertical guide 24′, 24″ that is integral with the slider 18′, 18″ and is extended along a respective vertical translation axis Z′, Z″.

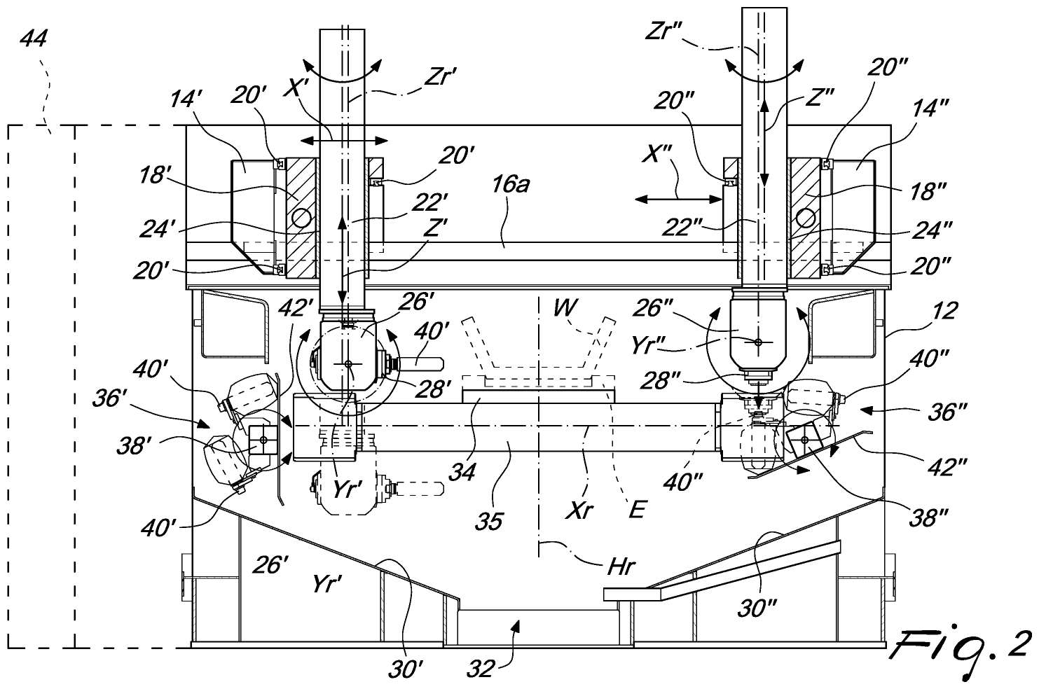

In particular, the machining head 22′, 22″ is provided, at its lower end, with a fork-like support 26′, 26″ (FIG. 2), by means of which it supports a tool holding spindle 28′, 28″ so that it can rotate about a horizontal rotation axis Yr′, Yr″. Preferably, the fork-like support 26′, 26″ can rotate about a vertical rotation axis Zr′, Zr″ which is parallel to, or coincides with, the respective vertical translation axis Z′, Z″.

The spindle 28′, 28″ can mount different types of tools for machining processes such as milling, boring, tapping, and the like.

According to a preferred embodiment of the disclosure, the supporting structure 12 has a base which comprises at least one chute which leads into a chip discharge area, advantageously two chutes 30′, 30″ which are longitudinally mutually opposite and lead into a central chip discharge area 32.

The base 30′, 30″ supports a rotating tool holding drum 35 the rotation axis Xr of which is extended in a horizontal and longitudinal direction. A workpiece holding table 34 is supported on the workpiece holding drum 35, preferably so that it can rotate about a rotation axis Hr of its own which is perpendicular to the rotation axis of the workpiece holding drum 35.

In this embodiment, the workpiece holding table 34 is advantageously arranged in a position that is centered longitudinally and offset transversely (i.e., the axis of the workpiece holding drum 35 is laterally offset with respect to the centerline of the machining center), for the purposes that will be clarified in greater detail hereinafter.

In a per se known manner, the workpiece W to be machined (shown schematically in dashed lines) can be fixed to the workpiece holding table 34 means of a workpiece holding fixture E (shown schematically in dashed lines).

The machining center 10 is provided with two mechanized tool magazines 36′, 36″, which are arranged at the opposite longitudinal ends of the supporting structure 12 so that they can be accessed by the two spindles 28′, 28″, respectively.

In this embodiment, each of the two tool magazines 36′, 36″ comprises a rotating tool holding drum 38′, 38″ which supports peripherally a plurality of tools 40′, 40″. The rotating tool holding drums 38′, 38″ are arranged so that their axes are horizontal and parallel to the transverse translation axes Y′, Y″. In each of the tool magazines 36′, 36″, the tools 40′, 40″ are arranged on one, two (as in the illustrated example) or even multiple angularly spaced rows of the respective tool holding drum 38′, 38″, said rows being extended 10 parallel to the axis of the respective tool holding drum 38′, 38″.

The spindles 28′, 28″ automatically pick up the tools 40′, 40″ to be used in the various machining steps from the respective mechanized tool magazines 36′, 36″, utilizing the mobility in space of the respective machining heads 22′, 22″. Depending on where the tool is located on the tool holding drum 38′, 38″, the drum is rotated so as to present the tools of one row or the other to the respective spindle 28′, 28″.

Advantageously, each of the tool magazines 36′, 36″ is provided with a shield 42′, 42″ which, in this embodiment, is fixed to the respective tool holding drum 38′, 38″. During machining, the tool holding drum 38′, 38″ is rotated so as to direct the respective shield 42′, 42″ toward the work area MA, so as to hide the respective tool magazine 36′, 36″ and protect it from the machining chips.

In an alternative embodiment, the shields might be movable independently of the respective drums.

Of course, all the above described movable components of the machining center are motorized by means of actuation systems of the conventional type, e.g., electric actuators, hydraulic actuators and/or pneumatic actuators, which are subjected to a control unit (not shown) in a manner which is per se conventional in the field.

An electric/fluidic control unit 44 (shown schematically in dashed lines in the figures) is arranged selectively at one of the two longitudinal ends of the supporting structure 12.

Of course, the supporting structure 12 can be provided with doors and windows for inspection (not shown) on one or more sides, in a manner which is per se conventional in the field.

In operation, the workpiece W to be machined is fixed on the rotating table 34 by means of the fixture E.

The workpiece W can be machined simultaneously by both spindles 28′, 28″, so as to increase productivity and, in some cases, even double it with respect to known solutions.

For example, the spindles 28′, 28″ can perform a same operation on two opposite sides of the workpiece W or, being completely independent, different operations by taking tools of a different type from the respective tool magazines 36′, 36″.

During machining, the shields 42′, 42″ protect the tool magazines 36′, 36″ from the machining chip, which therefore falls into the chip collection area 32 via the chutes 30′, 30″.

The spindles 28′, 28″ can move along the three Cartesian axes and can furthermore rotate about the respective transverse rotation axes Yr′, Yr″ and vertical rotation axes Zr′, Zr″. Additional degrees of freedom are provided by the rotation of the workpiece holding table 34 about its own axis and about the axis of the workpiece holding drum 35, so that any large workpiece, with a single positioning operation, can be machined substantially in any direction and on any side is directed toward the work area MA.

In an alternative embodiment, the fork-like supports 26′, 26″ might be nonrotatable about the vertical rotation axes Zr′, Zr″.

The workpiece holding table 34 also might be mounted so as to be fixed on the workpiece holding drum 35 instead of being rotatable about the axis Hr.

As the person skilled in the art will appreciate, one advantage of the disclosure is that the two carriages 14′, 14″ share the same tracks 16a, 16b for translation in a longitudinal direction. In this manner, each of the two spindles 28′, 28″ can “trespass”, in a longitudinal direction, onto the half of the work area that is occupied by the other spindle, thus offering high versatility.

In this preferred embodiment, the transversely offset position of the rotating table allows the spindles 28′, 28″ to machine workpieces that are even larger (as much as substantially twice the dimensions) with respect to the useful stroke of the horizontal guides 20′, 20″ (transverse axes Y′, Y″).

Some preferred embodiments of the disclosure have been described, but the person skilled in the art may of course apply various modifications and variations within the scope of the claims.

For example, the workpiece holding drum 35 might support two workpiece holding tables so that the two spindles 28′, 28″ can machine simultaneously two smaller workpieces, each mounted on a respective workpiece holding table. Although the machining center described and illustrated herein has been conceived to machine large workpieces, such as parts of the chassis or body in the automotive, aeronautical, nautical and similar sectors, it has in fact been observed in practice that the same principles can be applied to machining centers for machining medium-small workpieces, achieving several advantages.

Furthermore, the transversely offset position of the workpiece holding table is to be understood as an advantageous but not necessary characteristic of the disclosure.

The guiding means that allow the translation or rotation of the various movable elements of the machining center may be provided by means of technologies that are commonly used in the field, which are well known to the person skilled in the art, such as rotating supports or sliding supports which use rolling bearings, low-friction sliders, and the like.

The fork-like supports 26′, 26″ that rotatably support the spindles 28′, 28″ may of course be replaced with differently shaped rotary support means, e.g., rotating supports provided with a single arm instead of two parallel arms as in the case of the forks.

Although tool magazines of the type described above are particularly appreciated for their reliability, one or both of the tool magazines may of course be of a different type, e.g., chain-type tool magazines.

Finally, the functional order of the translation/rotation axes may of course be varied or reversed with respect to what has been described and illustrated.

1-11. (canceled)

12. A machining center comprising: two independent carriages, both supported, so as to slide along respective longitudinal translation axes, by a pair of parallel horizontal rails which are extended along a longitudinal direction and are fixed in a raised position to a supporting structure, each one of said independent carriages supporting a respective machining head configured to move along a respective transverse translation axis and along a respective vertical translation axis by respective guiding means, each machining head supporting a respective tool holding spindle so that it is configured to rotate about a horizontal rotation axis by rotary support means, said machining center further comprising a workpiece holding table which is supported at a base of said supporting structure so that it is configured to rotate about a first rotation axis which is extended in a horizontal and longitudinal direction, and two tool magazines supported at the opposite longitudinal ends of said supporting structure in order to be accessible by each one of said tool holding spindles.

13. The machining center according to claim 12, wherein said guiding means comprise, for each one of said carriages, a slider configured to slide along a respective horizontal guide which is integral with the carriage and is extended in a transverse direction, and, for each slider, a vertical guide which is integral with the slider and is engaged slidingly by a respective one of the machining heads.

14. The machining center according to claim 12, wherein said rotary support means comprise a fork-like support.

15. The machining center according to claim 12, wherein said supporting structure has a base which comprises at least one chute which leads into a chip discharge area.

16. The machining center according to claim 15, wherein said base comprises two longitudinally mutually opposite chutes which lead into the central chip discharge area.

17. The machining center according to claim 12, wherein said workpiece holding table is arranged in a position that is longitudinally centered and transversely offset.

18. The machining center according to claim 12, wherein at least one of said tool magazines comprises a rotating tool holding drum which is arranged so that an axis whereof is horizontal and transverse and supports peripherally a plurality of tools.

19. The machining center according to claim 12, wherein each one of said tool magazines is provided with a shield adapted to shelter, during machining, the respective tool magazine from machining chips.

20. The machining center according to claim 19, wherein said shield is fixed to the respective rotating tool holding drum.

21. The machining center according to claim 12, wherein each one of said rotary support means is configured to rotate about a vertical rotation axis which is parallel to, or coincides with, the respective vertical translation axis.

22. The machining center according to claim 12, wherein said workpiece holding table is supported so that it is also configured to rotate about a second rotation axis which is perpendicular to the first rotation axis.
